(19) United States
(12) Patent Application Publication
(10) Pub. No.: US 2026/0000063 A1
(43) Pub. Date: Jan. 1, 2026

(54) TECHNOLOGY CONFIGURED TO ENABLE CAPTURE AND/OR IDENTIFICATION OF INSECTS AND OTHER CREATURES

(71) Applicant: Jasgo R&D Pty Ltd, Double Bay, NSW (AU)

(72) Inventors: Joachim Anton Hermann Szangolies, Double Bay, NSW (AU); Mobin Nomvar, Double Bay, NSW (AU); Ta-Yuan Wang, Double Bay, NSW (AU); Thomas James Telfer, Double Bay, NSW (AU); Zachariah Gilmer Wylde, Double Bay, NSW (AU); Shane Joseph Cox, Double Bay, NSW (AU)

(21) Appl. No.: 19/112,138

(22) PCT Filed: Sep. 11, 2023
(86) PCT No.: PCT/AU2023/050874

§ 371 Date: Mar. 14, 2025

(30) Foreign Application Priority Data
Sep. 14, 2022 (AU) 2022902662

(51) Int. Cl. A01M 1/10; A01M 1/02; G06V 10/141; G06V 10/764; G06V 20/52

(52) U.S. Cl. CPC A01M 1/103; A01M 1/026; G06V 10/141; G06V 10/764; G06V 20/52; A01M 2200/011

(57) ABSTRACT

Technology is configured to enable capture and/or identification of insects and other creatures. The technology includes a device configured to capture and identify insects including bed bugs. The device includes a trap assembly and a monitoring unit. The monitoring unit includes an image capture module configured to capture image data in a capture zone of the trap assembly, a communications module, and a processing unit that is configured to cause the image capture module to capture images and to cause the communications module to communicate image data to a remote processing system. The remote processing system is configured to: receive a data transmission including the transmitted image data, determine a unique identifier representative of the processing unit, process the image data via a classifier module and define detection data representative of insects, and record the detection data in a database in association with the unique identifier of the processing unit.

### CROSS-REFERENCE TO RELATED APPLICATIONS

This application is a national phase entry under 35 U.S.C. § 371 of International Patent Application PCT/AU2023/050874, filed Sep. 11, 2023, designating the United States of America and published as International Patent Publication WO 2024/055065 A1 on Mar. 21, 2024, which claims the benefit under Article 8 of the Patent Cooperation Treaty of Australian Patent Application Serial No. 2022902662, filed Sep. 14, 2022.

### TECHNICAL FIELD

The present disclosure relates, in various embodiments, to technology configured to enable capture and/or identification of insects and other creatures. In a preferred implementation, the technology takes the form of a device configured to capture and identify insects including bedbugs. While some embodiments will be described herein with particular reference to those applications, it will be appreciated that the invention is not limited to such a field of use, and is applicable in broader contexts.

### BACKGROUND

Any discussion of the background art throughout the present disclosure should in no way be considered as an admission that such art is widely known or forms part of common general knowledge in the field.

Bedbugs are small parasitic insects from the genus Cimex that feed solely on the blood of animals, particularly humans. The most common species, Cimex lectularius, has a worldwide distribution and is common in cosmopolitan cities where tourism is high. The increase in international travel combined with a rise in pesticide resistance has seen a resurgence of bedbug infestations in the last few decades.

What is particularly insidious about bedbugs is their preference to live in small crevices and furniture, making them difficult and expensive to diagnose and eradicate once populations have become established. Additionally, the reaction to bedbug bites can vary from person to person, further hindering identification of infestations. In particular, while some people have immediate and significant reactions, for other people, there may be no reaction at all, and others still have a delayed itchiness meaning infestations may go for long periods without being detected. Furthermore, bedbug bites are similar in appearance and symptom to mosquito and tick bites, often requiring visual observation of a bedbug to confirm if the bite is from a bedbug before decisions around pest management can be made.

While the adults can be easily seen by a trained eye (approx. 5-7 mm in size), juvenile bedbugs are very small and pale and their eggs are even smaller, necessitating regular human intervention to monitor and identify infestations. Bedbug infestations have, and continue to have, a significant financial and reputational cost, particularly to the hospitality industry.

While there are commercial devices available to detect bedbugs, few are efficacious or suitable for wide-scale and long-term routine surveillance. Early detection of bedbugs or other pests (including cockroaches and silverfish) is a critical component of effective integrated pest management, not only to simplify treatment before infestations can escalate but also to prevent reputational damage prior to human identification.

Some attempts have been made to create automatic monitors using electrical components, however, these devices are often overly complicated and expensive, require external power sources, and/or rely on consumables that require regular servicing over short time intervals. The tiny body size, mobility, and nocturnal behavior of bedbugs make it nearly impossible to prevent an infestation so devices and methods for early detection remain highly desirable, especially within the hospitality industry.

### BRIEF SUMMARY

It is an object of the present disclosure to overcome or ameliorate at least one of the disadvantages of the prior art, or to provide a useful alternative.

One embodiment of the present disclosure provides a trap device configured to facilitate identification and capture of insects, the device including:
a trap assembly, the trap assembly including:
   (i) one or more passageways through which an insect is able to crawl, each aperture having an external opening and in internal opening;
   (ii) a cavity into which the internal openings feed; and
   (iii) a pitfall trap arrangement within the cavity, such that an insect that crawls through one of the passageways and egresses through the internal opening of that passageway is transported into a capture zone of the pitfall trap arrangement; and
a monitoring unit, the monitoring unit including:
   (i) an image capture module configured to capture image data for a field of view that includes the capture zone;
   (ii) a communications module; and
   (iii) a processing unit that is configured to execute logical instructions thereby to cause the image capture module to capture images in accordance with a predefined capture protocol, and the communications module to communicate resultant image data to a remote processing system in accordance with a predefined transmission protocol;
wherein the remote processing system is configured to:
   (i) receive a data transmission including at least one instance of image data transmitted by the trap device processing unit;
   (ii) determine a unique identifier representative of the processing unit;
   (iii) process the instance of image data via a classifier module, thereby to define detection data representative of identified presence of one or more insects of known insect types;
   (iv) record the detection data in a database such that the detection data is associated with the processing unit via the unique identifier of the processing unit.

One embodiment provides a trap device including one or more infrared lights that are configured to illuminate the capture zone during image capture.

One embodiment provides a trap device wherein the classifier module is a trained classifier module, wherein the classifier module is trained using labelled images of insects of one or more insect types captured under infrared illumination.

One embodiment provides a trap device wherein the capture zone includes a capture surface on which the insect is maintained following transportation into the capture zone, wherein the surface is configured to absorb infrared light.

One embodiment provides a trap device wherein the capture surface is textured to absorb infrared light.

One embodiment provides a trap device wherein the capture surface is formed of a textured plastic.

One embodiment provides a trap device wherein the trap assembly includes a base, and a sidewall assembly upwardly extending from the base to a sidewall assembly top edge, wherein the one or more passageways are formed though the sidewall assembly.

One embodiment provides a trap device wherein the one or more passageways are formed by gaps between the sidewall assembly top edge and a base of the monitoring unit.

One embodiment provides a trap device wherein the monitoring unit is housed in a monitoring unit body provided by the trap assembly, which is mounted to the sidewall assembly top edge via one or more connector members, wherein the connector members facilitate the openings such that each opening is bound at its vertical sides by edges of adjacent connector members, at its horizontal sides by the sidewall assembly and the monitoring unit.

One embodiment provides a trap device wherein the monitoring unit body covers a top of the cavity.

One embodiment provides a trap device wherein the monitoring unit body includes a base surface configured to enable: (i) downward image capture by the image capture module through the cavity toward the capture zone; and (ii) illumination of the capture zone by one or more infrared lights.

One embodiment provides a trap device wherein the sidewall assembly tapers inwards between the base and the sidewall assembly top edge.

One embodiment provides a trap device wherein the cavity is encircled by a cavity sidewall, wherein the cavity sidewall is configured to inhibit upward crawling by an insect.

One embodiment provides a trap device wherein the cavity sidewall is formed of a smooth material such that it is configured to inhibit upward crawling by an insect.

One embodiment provides a trap device wherein the cavity sidewall tapers inwardly from a top edge to a bottom edge.

One embodiment provides a trap device wherein the bottom edge adjoins the capture zone.

One embodiment provides a trap device including a removable lure module that is mounted proximate to the capture zone.

One embodiment provides a trap device wherein the capture zone of the trap assembly includes a porous base, thereby to enable dissemination of scent from a lure positioned underneath the capture zone.

One embodiment provides a trap device wherein the device includes a battery power supply, and wherein the image capture protocol and the data transmission protocol are configured to optimize battery power conservation.

One embodiment provides a method for monitoring presence of insects of one or more defined insect types, the method including:
receiving data transmissions from a plurality of networked trap devices, wherein each networked trap device has a unique identifier and is configured to periodically transmit instances of image data;
in respect of a given data transmission:
   (i) receiving the data transmission including at least one instance of image data transmitted by the trap device processing unit;
   (ii) determining a unique identifier representative the one of the networked trap devices that transmitted the data transmission;
   (iii) processing the instance of image data via a classifier module, thereby to define detection data representative of identified presence of one or more insects of known insect types;
   (iv) recording the detection data in a database such that the detection data is associated with the processing unit via the unique identifier of the processing unit.

One embodiment provides a method wherein the trap devices include trap devices according to any embodiment described herein.

One embodiment provides a method wherein: the instance of image data is captured under illumination of infrared light; and wherein the classifier module is a trained classifier module, wherein the classifier module is trained using labelled images of insects of one or more insect types.

One embodiment provides a system for pest management including a plurality of trap devices as described herein and a computer system configured to perform a method as described herein.

Reference throughout this disclosure to “one embodiment,” “some embodiments,” or “an embodiment” means that a particular feature, structure or characteristic described in connection with the embodiment is included in at least one embodiment of the present disclosure. Thus, appearances of the phrases “in one embodiment,” “in some embodiments,” or “in an embodiment” in various places throughout this disclosure are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising,” “comprised of,” or “which comprises” is an open term that means including at least the elements/features that follow, but not excluding others. Thus, the term “comprising,” when used in the claims, should not be interpreted as being limitative to the means or elements or steps listed thereafter. For example, the scope of the expression a device comprising A and B should not be limited to devices consisting only of elements A and B. Any one of the terms “including,” “which includes,” or “that includes,” as used herein, is also an open term that also means including at least the elements/features that follow the term, but not excluding others. Thus, “including” is synonymous with and means “comprising.”

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the present disclosure will now be described, by way of example only, with reference to the accompanying drawings in which:

FIG. 1 provides a schematic illustration of an example system including an example trap device.

FIG. 2A illustrates a device according to one embodiment, shown as a side view.

FIG. 2B shows a top view of a lower trap assembly component for the device of FIG. 2A.

FIG. 2C provides an exploded side view for the device of FIG. 2A.

### DETAILED DESCRIPTION

The present disclosure relates, in various embodiments, to technology configured to enable capture and/or identification of insects and other creatures. In a preferred implementation, the technology takes the form of a device configured to capture and identify insects including bedbugs. While some embodiments will be described herein with particular reference to those applications, it will be appreciated that the invention is not limited to such a field of use, and is applicable in broader contexts.

Embodiments include trap devices themselves, computer-implemented methods implemented by trap devices, computer systems configured to receive and process data collected at trap devices, computer-implemented methods implemented by such computer systems, methods by which pest identification is performed and presented to end users in a networked environment, and method by which classifiers (e.g., neural network classifiers) are trained thereby to facilitate identification of specific types of pest (for example, insects including bedbugs).

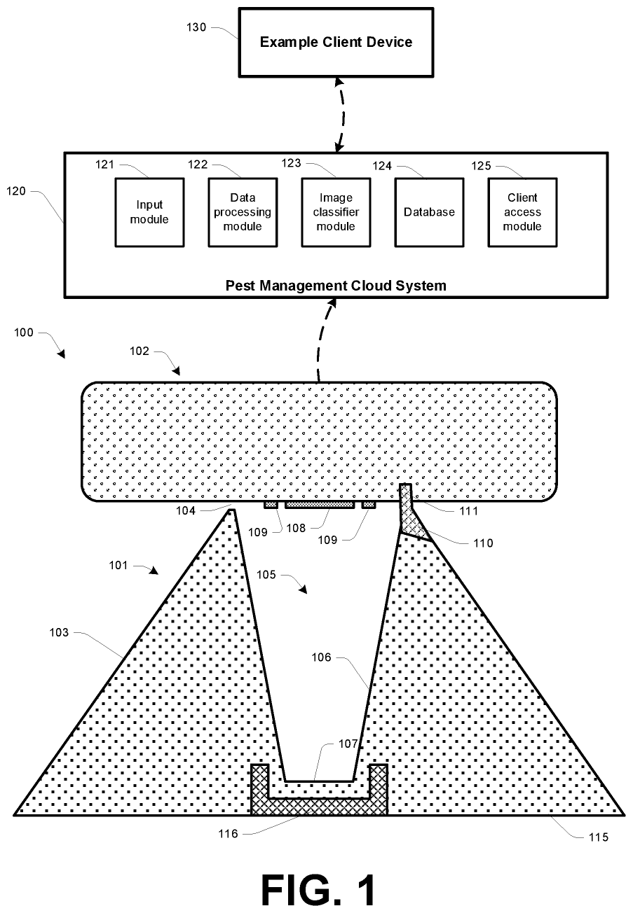

FIG. 1 illustrates a simplified schematic view of an end-to-end system according to one embodiment. It will be appreciated that components are illustrated in a manner intended to demonstrate key features; further embodiments that show aspects of example industrial design and detailed configuration for molded components are provided elsewhere in the drawings.

The end-to-end system of FIG. 1 includes:
An example trap device 100. In practice, numerous trap devices of this form are deployed at various locations, for example, throughout a hotel or other building/facility.
An example pest management cloud system, 120. This may be defined by one or a plurality of computing devices, which are networked and accessible via the Internet. System 120 is configured to receive data transmissions over the Internet from trap device 100 and a plurality of other trap devices.
An example client device 130, which is configured to render a user interface that presents data made available by system 120. For example, client device 130 may be a smartphone, tablet, or PC that executes a software application (e.g., a web browser or downloadable application), that software application being configured to access and present select information made available via system 120.

In overview, trap devices such as device 100 are deployed in various locations. Each trap device has a unique identifier (UID), and a given user is able to register a plurality of trap devices to a user account. The trap devices transmit data to system 120, which is configured to process that data thereby to identify presence of specific insects (e.g., bedbugs) in the traps, and record that data in a database. The data is stored such that each trap device is associated with a user account, and a set of detection data. In this manner, a user of a device 130 is enabled to log-in via credentials associated with their user account, and view current and historic data for each of the user's associated trap devices. System 120 may also be configured to enable push notifications, for example, to alert a user of a device 130 when bedbug activity is detected in one or more of their trap devices.

In this manner, the end-to-end system enables users to efficiently identify presence of specific pests (such as bedbugs) in locations for which they are responsible.

Identification of specific pests is, at least in some embodiments, facilitated by an AI classifier module, which is trained thereby to classify image data thereby to output data representative of specific detected pests (such as bedbugs). This is preferably trained via a machine learning process using labelled data. In a preferred embodiment, at least a portion of the image data (and classifier training data) is captured using infrared illumination (although there are advantages to additionally including training image data captured under visible light spectrum illumination). It has been recognized that image capture under infrared illumination presents specific advantages. In particular, it has been identified that bedbugs exhibit a distinctive reflective pattern under infra-red light, enhancing their identification against other insects when these captured images were exposed to an AI classifier.

It should be appreciated that, while embodiments described herein are primarily directed for the detection and identification of bedbugs; in particular, an AI classifier may be trained to identify a plurality of other insect (and other pest) types.

Trap device 100 of FIG. 1 is a trap device configured to facilitate identification and capture of insects. Device 100 includes a trap assembly 101, which in this example is substantially a truncated cone in shape (FIG. 1 shows this in a side sectional view). Trap assembly 101 has a base 115, and a sidewall assembly 103 upwardly extending from the base to a sidewall assembly top edge. The external surface of the sidewall assembly is formed from a textured plastic material, which encourages crawling insects to climb up the sidewall (various other materials may be used, for example, cardboard, wood, and the like). This external surface also provides an upwards pathway, which has been identified as being favorable for bedbugs. Bedbugs are unlikely to be found in areas where they cannot climb; they have a tendency to move up any upwardly sloping surface to reach a host or a harborage close to a host (to lay eggs and reproduce). The pitch of external surface of the sidewall assembly has been designed to encourage bedbugs to climb upward.

One or more passageways 104 are formed, thereby to enable insects crawling up sidewall assembly 103 to travel into an internal trap cavity 105, and subsequently into a capture zone 107. These passageways are preferably peripherally spaced about the top edge of the sidewall assembly. In the present embodiment the passageways are defined by peripherally extending gaps between the sidewall assembly and overlying monitoring unit 102. In another embodiment, the passageways may be formed though the sidewall assembly proximal the sidewall assembly top edge. The passageways are relatively narrow in size (for example, having a height of under 5 mm, and more preferably under 3 mm). In embodiments where peripherally extending passageways are used, these preferably have a peripheral length of under 60 mm, and preferably under 40 mm. This exploits an observation that that bedbugs are known to crawl into and live in dark crevices, like many other pests (e.g., German cockroaches). Exploiting this behavioral bias results in a more effective capture rate when compared to open pitfall designs in known traps. The use of narrow entry ports is unintuitive, as conventional wisdom in the trap industry is that larger entry ports would result in higher capture rates.

Passageways 104 lead into a cavity 105 defined by trap assembly 101. Accordingly, device 100 includes one or more passageways through which an insect is able to crawl, each aperture having an external opening and in internal opening, with the internal openings deeding into cavity 105. A pitfall trap arrangement is defined in cavity 105, such that an insect that crawls through one of the passageways and egresses through the internal opening of that passageway is transported into a capture zone 107 of the pitfall trap arrangement. A steep edge is provided at the junction between the pitfall and the passageway. Observations have shown that bedbugs are more likely to fall into the trap if the leading edge on the perimeter of the pitfall is steep. If the edge is mitered/gradual, then they will often nestle into this and roam around the perimeter without falling into the trap.

In a preferred embodiment, the cavity is encircled by a cavity sidewall 106, the cavity sidewall 106 being configured to inhibit upward crawling by an insect. In this regard, the cavity sidewall is formed of a smooth material (such as polished plastic) such that it is configured to inhibit upward crawling by an insect, and the cavity sidewall 106 tapers inwardly on a steep angle from a top edge to a bottom edge. The bottom edge adjoins capture zone 107.

In some embodiments, a removable lure module 116 is mounted proximal the capture zone. For example, this may be removably engaged with the trap assembly (e.g., snap lock, pressure fit, threaded fit, or the like), and can optionally be used to contain various forms of insect lure. The capture zone 107 is preferably porous; for example, this is useful in an embodiment where a scented lure is contained in the lure module 116, allowing dissemination of the lure's scent into the trap thereby to attract insects. In some cases there is no lure in the lure module, and in further embodiments the lure module is excluded altogether.

In the example of FIG. 1, a plurality of connector components 110 are mounted at peripherally spaced locations at the top edge of sidewall assembly 103. These each have a connector member 111, which engages with monitoring unit 102. For example, the connecting members are configured for snap locking engagement (or other forms of engagement, including friction fit engagement) with apertures formed in the monitoring unit body. The connection between the sidewall assembly and monitoring unit via components 110 is achieved such that peripherally extended passageways 104 are defined in spaces each bound by: opposed edges of adjacent connector components 110; the upper edge of sidewall assembly 103, and the base surface of monitoring unit 102.

In the illustrated embodiment, the monitoring unit 102 covers a top of cavity 105 defined by trap assembly 101. As such, the pitfall trap when sheltered by the overhang of the mounting unit creates a dark environment within the cavity that is particularly attractive for insects like bedbugs and cockroaches, that like to inhabit dark crevices. This design was intentional to maximize the trap's insect attraction rate.

Monitoring unit 102 houses various electrical components. These include an image capture module (e.g., digital camera) configured to capture image data for a field of view, which includes capture zone 107. In the example of FIG. 1, the monitoring unit body includes a base surface configured to enable downward image capture by the image capture module through cavity 105 toward the capture zone 107. The camera 108 lens is surrounded by a diffuser thereby to enhance quality of captured images. The monitoring unit body base surface also allows illumination of capture zone 107 by one or more infrared lights 109.

Capture zone 107 includes a capture surface on which the insect is maintained following transportation into the capture zone. This surface is configured to absorb infrared light. For example, the capture surface is preferably formed of a textured plastic thereby to absorb UV light and mitigate risks of camera image oversaturation. In this manner, images captured by the capture device under infrared illumination are tuned to reveal distinct patterns displayed by bedbugs (and optionally other insects), which enables a suitably trained AI classifier to perform automated detection of bedbugs (and optionally other insects) in images.

The use of IR light to illuminate images and prevent the discouragement of insects that are negatively phototactic from entering the trap (typically white light is used). It is well known that many insects cannot see well if at all in the red spectrum of light. Based on spectral sensitivity data, it has been shown that bed bugs (Cimex lectularius) do not possess the photopigments that specifically absorb red light (McNeil et al 2016).

Monitoring unit 102 additionally includes a communications module, which is preferably a Wi-Fi module (although other communications means including Bluetooth and cellular may be used). A processing unit that is configured to execute logical instructions thereby to cause the image capture module to capture images in accordance with a predefined capture protocol, and the communications module to communicate resultant image data to a remote processing system in accordance with a predefined transmission protocol. In embodiments where the device includes a battery power supply (which is preferred thereby enable wire-free deployment), the logical instructions are defined thereby to configure the image capture protocol and the data transmission protocol to optimize battery power conservation. For example, this may include setting a schedule for activation/operation of the camera module and infrared lights to capture images on a periodic basis (for example, every X minutes, where X is between 5 and 240). Wi-Fi communications may be activated on a corresponding schedule, or a less regular schedule (thereby to transmit a batch of collected images). Those skilled in the art will be familiar with various power conservation approaches suitable for devices such as this.

In one embodiment, device 100 is configured to capture an image every X minutes (for example, X may be set at 30 minutes). An algorithm in the firmware of the capture module performs a brightness count and if that's above a defined threshold, the image will be uploaded to the cloud (as the brightness would be representative of a reflection from an insect or other object). If there's nothing in the trap's capture zone, and the brightness count fails to meet a predefined threshold (this threshold being set as a means to assess presence of an insect that reflects under IR illumination), the image is not uploaded as a power saving measure. As a failsafe, if the device runs for a threshold period without capturing an image with threshold brightness count, it is configured to upload an image as a life/status check. This may be configured to occur, for example, on a daily basis. Dynamic timing may be used based on battery conservation parameters.

Ultimately, trap device 100 is configured to periodically transmit data sets to system 120, each data set including a UID representative of the device, and one or more instances of image data captured by the camera module (being images of capture zone 107 taken under infrared illumination). These data sets are received via the Internet by system 120, which performs methods as described below.

System 120 includes an input module 121, which is configured for receiving data transmissions from a plurality of networked trap devices (including device 100). In respect of a given data transmission, a data processing module 122 unpacks the transmission and determines a unique identifier representative of the one of the networked trap devices that transmitted the data transmission. An image classifier module 123 is configured to process the instance of image data, thereby to define detection data representative of identified presence of one or more insects of known insect types. For example, the classifier module is an AI classifier module trained based on training data, which includes labelled data of bedbugs illuminated under infrared light. Processing module 122 receives output of classifier module 123, and in response records detection data in a database 124 such that the detection data is associated with the processing unit via the unique identifier of the processing unit.

The classifier preferably uses a deep Convolution Neural Network Model (CNN) that employs a supervised learning process. The classifier is preferably trained via labelled data thereby to operate effectively for multiple species of insect, for example, cockroaches, bed bugs, and silverfish. Additionally, the classifier is configured to enable identification of single and multiple artefacts (e.g., insects) in a single image. Those skilled in the art will be familiar with various CNN classifiers that may be employed for purposes described herein.

A client device 130 accesses data in database 124 via a client access module 125. For example, client device 130 executes a software application (e.g., a web browser) that triggers a request to module 125 thereby to trigger download of historical detection data for one or more traps to which the client device has access. In some embodiments, client access module 125 is additionally configured to execute rules thereby to trigger push notifications to one or more client devices, thereby to, for instance, provide alerts in the event that bedbugs are detected at one or more of a user's trap devices.

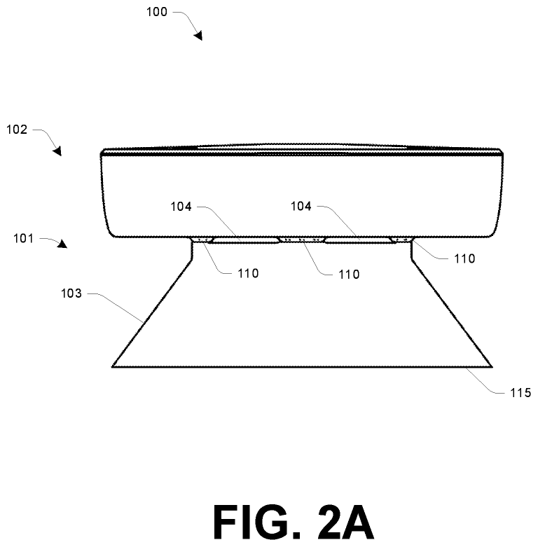

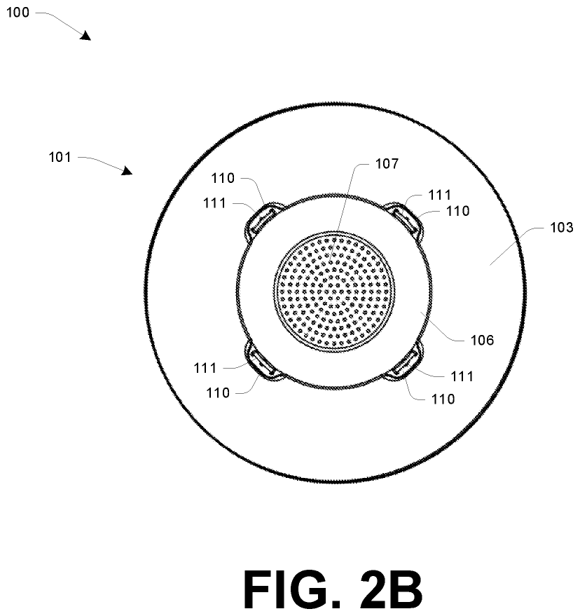

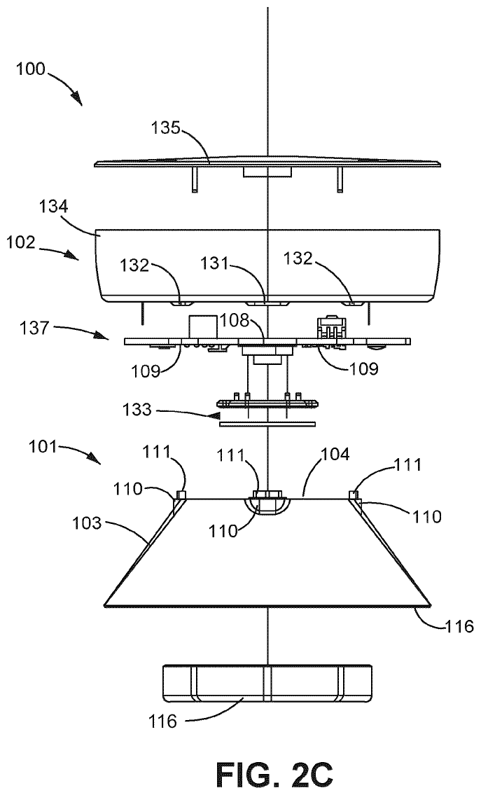

FIG. 2A, FIG. 2B and FIG. 2C illustrate a further example of device 100. Corresponding features have been designated by reference numerals used in FIG. 1.

FIG. 2A illustrates a device according to one embodiment, shown as a side view. This side view shows three peripherally spaced connector components 110, and between these, two distinct openings 104. In this example, sidewall assembly 103 includes a steepened region proximal its top edge; it will be appreciated that the precise shape of the sidewall assembly is to some extent a matter of design choice, and that various other configurations may be used in further embodiments.

FIG. 2B shows a top-down view of a lower trap assembly component for the device of FIG. 2A. That is, the monitoring unit is not present in FIG. 2B. This provides a clear view of an example of capture zone 107 having a porous base, which in some cases is optionally used to enable dissemination of scent from a lure positioned underneath capture zone 107 (for example, in lure module 116).

FIG. 2C provides an exploded side view for the device of FIG. 2A. In this diagram, and example of passageway 104 is indicated by a dashed rectangle. Several additional components are show in this diagram, being: (i) a circuit board 137, which contains various electronic components of the monitoring module (including processing components, communications components, a power supply, IR LEDs 109 and camera module 108); (ii) a formation 131 formed in a base of the monitoring unit body through which the camera 108 is directed; (iii) formations 132 formed in a base of the monitoring unit body through which infrared LEDs are directed; (iv) a lens cover/diffuser arrangement 133 that covers formation 131 thereby to protect and improve the operation of camera 108; and (v) a lower monitoring unit body part 134 and upper monitoring body unit part 135 that connect together thereby to define a container in which circuit board 137 is contained.

It will be appreciated that the disclosure above provides for management of insects and other pests, including enabling positive identification if bedbugs via a set of networked traps.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this disclosure, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure, for example, in relation to the operation of system 120, may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

A system and method of the present disclosure may be implemented and run on a general-purpose computer or special-purpose computer system. The terms “computer system” and “computer network” as may be used in the present disclosure may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present disclosure may include and may be included within fixed and portable devices such as desktop, laptop, and/or server. A module may be a component of a device, software, program, or system that implements some “functionality,” which can be embodied as software, hardware, firmware, electronic circuitry, or the like.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments, but only by the scope of the appended claims.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this disclosure.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B that may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present disclosure.

1. A trap device configured to facilitate identification and capture of insects, the device including:
a trap assembly, the trap assembly including:
(i) one or more passageways through which an insect is able to crawl, each aperture having an external opening and in internal opening;
(ii) a cavity into which the internal openings feed; and
(iii) a pitfall trap arrangement within the cavity, such that an insect that crawls through one of the passageways and egresses through the internal opening of that passageway is transported into a capture zone of the pitfall trap arrangement; and
a monitoring unit, the monitoring unit including:
(i) an image capture module configured to capture image data for a field of view that includes the capture zone;
(ii) a communications module; and
(iii) a processing unit that is configured to execute logical instructions thereby to cause the image capture module to capture images in accordance with a predefined capture protocol, and the communications module to communicate resultant image data to a remote processing system in accordance with a predefined transmission protocol;
wherein the remote processing system is configured to:
(i) receive a data transmission including at least one instance of image data transmitted by the trap device processing unit;
(ii) determine a unique identifier representative of the processing unit;
(iii) process the instance of image data via a classifier module, thereby to define detection data representative of identified presence of one or more insects of known insect types; and
(iv) record the detection data in a database such that the detection data is associated with the processing unit via the unique identifier of the processing unit.

2. The device of claim 1, further comprising one or more infrared lights configured to illuminate the capture zone during image capture.

3. The device of claim 2, wherein the classifier module is a trained classifier module, and wherein the classifier module is trained using labelled images of insects of one or more insect types captured under infrared illumination.

4. The device of claim 2, wherein the capture zone includes a capture surface on which the insect is maintained following transportation into the capture zone, wherein the surface is configured to absorb infrared light.

5. The device of claim 4, wherein the capture surface is textured to absorb infrared light.

6. The device of claim 4, wherein the capture surface is formed of a textured plastic.

7. The device of claim 1, wherein the trap assembly includes a base and a sidewall assembly upwardly extending from the base to a sidewall assembly top edge, wherein the one or more passageways are formed though the sidewall assembly.

8. The device of claim 7, wherein the one or more passageways are formed by gaps between the sidewall assembly top edge and a base of the monitoring unit.

9. The device of claim 7, wherein the monitoring unit is housed in a monitoring unit body of the trap assembly, the monitoring unit body mounted to the sidewall assembly top edge via one or more connector members, wherein the one or more connector members define the openings such that each opening is bound at vertical sides thereof by edges of adjacent connector members, and at horizontal sides thereof by the sidewall assembly and the monitoring unit.

10. The device of claim 9, wherein the monitoring unit body covers a top of the cavity.

11. The device of claim 10, wherein the monitoring unit body includes a base surface configured to enable: (i) downward image capture by the image capture module through the cavity toward the capture zone; and (ii) illumination of the capture zone by one or more infrared lights.

12. The device of claim 7, wherein the sidewall assembly tapers inward between the base and the sidewall assembly top edge.

13. The device of claim 1, wherein the cavity is encircled by a cavity sidewall, and wherein the cavity sidewall is configured to inhibit upward crawling by an insect.

14. The device of claim 13, wherein the cavity sidewall is formed of a smooth material configured to inhibit upward crawling by an insect.

15. The device of claim 13, wherein the cavity sidewall tapers inwardly from a top edge to a bottom edge.

16. The device of claim 15, wherein the bottom edge adjoins the capture zone.

17. The device of claim 1, further comprising a removable lure module mounted proximate to the capture zone.

18. The device of claim 1, wherein the capture zone of the trap assembly includes a porous base to enable dissemination of scent from a lure positioned underneath the capture zone.

19. The device of claim 1, further comprising a battery power supply, and wherein the image capture protocol and the data transmission protocol are configured to optimize battery power conservation.

20. A method for monitoring presence of insects of one or more defined insect types, the method including:
receiving data transmissions from a plurality of networked trap devices, wherein each networked trap device has a unique identifier and is configured to periodically transmit instances of image data; and
in respect of a given data transmission:
(i) receiving the data transmission including at least one instance of image data transmitted by a trap device processing unit;
(ii) determining a unique identifier representative the one of the networked trap devices that transmitted the data transmission;
(iii) processing the instance of image data via a classifier module, thereby to define detection data representative of identified presence of one or more insects of known insect types; and
(iv) recording the detection data in a database such that the detection data is associated with the processing unit via the unique identifier of the processing unit.

21. The method of claim 20, wherein the trap devices comprise trap devices according to claim 1.

22. The method of claim 20, wherein the instance of image data is captured under illumination of infrared light; and
wherein the classifier module is a trained classifier module, wherein the classifier module is trained using labelled images of insects of one or more insect types.

23. (canceled)
